(19) United States
(12) Patent Application Publication
(10) Pub. No.: US 2026/0307541 A1
(43) Pub. Date: Oct. 8, 2026

(54) METHOD, CONTROLLER AND ELECTRIC VEHICLE FOR UNEVEN BATTERY HEATING OF THE TRACTION BATTERIES

(71) Applicant: Scania CV AB, Södertälje (SE)

(72) Inventors: Abhiram Mukund RAHATGAONKAR, Huddinge (SE); Linus SJÖVALL, Täby (SE)

(73) Assignee: Scania CV AB, Södertälje (SE)

(21) Appl. No.: 19/481,300

(22) PCT Filed: May 3, 2024
(86) PCT No.: PCT/SE2024/050426

§ 371 Date: Nov. 4, 2025

(30) Foreign Application Priority Data
May 11, 2023 (SE) 2350576-1

(51) Int. Cl. B60L 58/27; B60L 58/12; H01M 10/48; H01M 10/615; H01M 10/625; H01M 10/633; H01M 10/656; H01M 50/204

(52) U.S. Cl. CPC B60L 58/27; B60L 58/12; H01M 10/482; H01M 10/486; H01M 10/615; H01M 10/625; H01M 10/633; H01M 10/656; H01M 50/204; B60L 2240/545; H01M 2220/20

(57) ABSTRACT

A method is described which is performed by an electric vehicle controller, in which the vehicle has multiple battery packs, each with its own heating arrangement to individually adjust the respective battery pack temperatures. The method involves detecting when the temperature of the battery packs falls below a specified lower threshold level. Upon detection, the heating arrangement is allowed to provide heat to a distinct first set of battery packs while being disallowed from providing heat to a separate second set of battery packs. This selective heating strategy occurs when the battery temperature is found to be below the lower threshold level. A corresponding controller and an electric vehicle are also described.

### CROSS-REFERENCE TO RELATED APPLICATIONS

This application is a national stage application (filed under 35 U.S.C. § 371) of PCT/SE2024/050426, filed May 3, 2024, of the same title, which in turn claims priority to Swedish Patent App. No. 2350576-1, filed on May 11, 2023; the contents of each of which are hereby incorporated herein by reference.

### TECHNICAL FIELD

This document discloses a method, a controller, a computer program, a computer program product and an electric vehicle. The electric vehicle comprises a plurality of battery packs, each associated with a heating arrangement. The heating arrangement is configured to adjust temperature of each respective battery pack individually. The method comprises detecting a battery temperature below a lower threshold level of the battery packs. The method also comprises allowing the heating arrangement to provide heat to a first set of battery packs, while disallowing the heating arrangement to provide heat to a second set of battery packs when the battery temperature is detected below the lower threshold level.

### BACKGROUND

A vehicle with an electrical propulsion system comprises a rechargeable traction battery. In the case of heavy electric vehicles such as trucks, busses etc., a plurality of traction battery packs are normally required for propulsion of the vehicle. These traction battery packs may be arranged in series and/or in parallel to provide necessary voltage/power performance. Also, for cases of weight distribution and driving properties of the vehicle, as the battery packs are relatively heavy, the battery packs are often distributed at different distinct locations of the heavy vehicle.

By introducing traction battery packs for vehicle propulsion instead of combustion engine, various attractive advantages are reached such as less pollution/emissions of carbon dioxide and/or nitrous oxide, reduced noise from the vehicle during propulsion, reduced operating costs (for fuel), and/or reduced maintenance/service costs in comparison with vehicles with internal combustion engine.

However, despite the numerous advantages with the concept of electrical vehicles per se, and the rather long time of technological development within the field, large scale implementation of heavy electrical vehicles has, so far, failed to materialise. One reason is the problem of low battery performance in cold temperatures.

A disadvantage with traction battery packs, in comparison with combustion engines, is that performance of the battery packs is dependent on temperature of the battery pack, besides State of Charge (SOC) level. Low temperature power performance of traction battery packs used for electrical vehicles is very limited and may often be below the minimum power requirements in arctic/subarctic regions at wintertime, e.g. at temperatures of below −10° C.

Electrochemical reasons are behind this performance drop of traction battery packs at low temperatures, partly due to the increase in internal resistance that reduces the available current from the battery pack.

This is a problem occurring primarily when starting the vehicle with cold battery packs and during the first period after start as the temperature of the battery packs gradually will increase (due to the internal resistance) during usage.

A known solution to this problem is to apply a heater to the battery packs and to heat them up, preferably before starting the vehicle while the vehicle is plugged to a battery charger for charging the battery packs. Thereby both the SOC level of the battery packs and the temperature is increased while the internal resistance is reduced. Another possible solution is to park the vehicle indoors in a heated garage over night or during breaks.

However, these known solutions may not be available for the vehicle, for example when operating in remote uninhabited outback or when forced to make an unplanned stop, for example. The planned battery charger may be occupied or out of function, for example.

A possible solution available to the driver/vehicle in case he/she find him/herself without vehicle external power source, may be to use battery power to run the heater for the battery packs. Battery packs of a heavy vehicle are relatively big and heavy, i.e. involve a high thermal mass. Thus, heating the vehicle battery packs takes time and may risk draining the battery packs faster than the battery packs are heated, in a vicious circle.

It appears that in order to reach a practical implementation of vehicles with electrical propulsion system, at least in arctic/subarctic climate zones, further development is required, providing a solution to the above discussed problems.

### SUMMARY

It is an object of this invention to solve or alleviate at least some of the above problems and improve low temperature performance of an electric vehicle.

According to a first aspect of the invention, this objective is achieved by a method performed by a controller of an electric vehicle. The vehicle comprises a plurality of battery packs, each associated with a heating arrangement. The battery packs may be referred to as modules or subsets of the total amount of electricity storage devices onboard the electric vehicle for supporting onboard electricity consumers with electricity, upon request, for example for propulsion of the electric vehicle. Other terminology that may be used for the battery packs may be e.g. battery, traction battery, electric vehicle battery, battery cells, battery module/s, power pack.

Irrespective of terminology, the battery packs, or at least some sub sets of the battery packs are displaced at physically distinct portions of the vehicle, in order to distribute the weight of the battery packs on the vehicle, for improving or at least not affecting the driving properties of the vehicle.

The heating arrangement is configured to adjust temperature of each respective battery pack individually. The method comprises detecting a battery temperature below a lower threshold level of all the battery packs, i.e. detecting that all of the battery packs have a battery temperature below a lower threshold level.

In case one or some battery pack/s has a temperature exceeding the lower threshold level, that battery pack/s may be selected for vehicle propulsion, as this/these battery pack/s has/have a lower internal resistance than battery pack/s having a temperature below the lower threshold level, thereby enabling a higher power output than the battery pack/s having a temperature below the lower threshold level.

In case however all battery packs have a detected temperature lower than the lower threshold level, the heating arrangement is allowed to provide heat to a first set of battery packs out of the plurality of battery packs, while disallowing the heating arrangement to provide heat to a second set of battery packs out of the plurality of battery packs. The first set of battery packs is distinct from the second set of battery packs.

Hereby a heating strategy is disclosed that focuses on uneven heating of the battery packs of the vehicle in order to create temperature difference between the battery packs. The strategy is to provide heating only to one or some few battery packs by the heater instead of heating all the battery packs onboard.

By using the method, the temperature of one or some few battery packs can increase rapidly as compared to the case when all the battery packs are heated simultaneously. The time it takes to reach high or at least satisfying amount of power at very low temperature after cold start of heavy vehicles is minimized or at least reduced, in comparison with previously known solutions. High power operations may be performed earlier after a cold start resulting in enhanced uptime of the vehicle in sub-zero temperatures. Another advantage is that demands on the heater can be relaxed, leading to cheaper and cost efficient design without compromising on the vehicle performance. Also the demands on the minimum number of battery packs or the low temperature performance specifications of the battery packs can be relaxed without compromising the vehicle performance.

Optionally, the method according to the first aspect may comprise monitoring a battery temperature of the battery packs comprised in the first set of battery packs, when the heating arrangement has been allowed to provide heat to the first set of battery packs. Also, the method may comprise disallowing the heating arrangement to provide heat to the first set of battery packs and allowing the heating arrangement to provide heat to the second set of battery packs when the monitored battery temperature of the battery packs in the first set of battery packs exceeds an upper threshold level.

When the temperature of the first set of battery packs has reached the upper threshold level, the output power performance of the first set of battery packs has increased due to reduced internal resistance as a consequence of the increased temperature, to a level allowing the power output according to the demands of the electric vehicle. The critical phase during the beginning of the cold-start take off with very cold battery packs is over. By shifting focus to heat up the second set of battery packs, the capacity in terms of available power output of these battery packs is increased.

Optionally, the method according to the first aspect may comprise estimating State of Charge (SOC) of each respective battery pack. The method may also comprise adjusting the lower threshold level and/or an upper threshold level of the battery temperature, based on the estimated SOC.

The output power capacity of the battery packs is deteriorating with falling temperature, but is also affected by decreasing SOC. By adjusting the lower threshold level and/or the upper threshold level of the battery temperature taking regard to the estimated SOC, a better precision in achieving a certain required power demand of the electric vehicle is provided.

Optionally, the lower threshold level and/or the upper threshold level of the battery temperature may be adjusted based on power requirements of the vehicle and/or available power in the first set of battery packs.

By adjusting the lower threshold level and/or the upper threshold level of the battery temperature taking regard to the power requirements of the vehicle and/or available power in the first set of battery packs, efficient heating of the battery packs is provided.

Optionally, the battery packs comprised in the first set of battery packs and/or the second set of battery packs may be selected based on historical data over previously made selections for distributing the selection equally over time.

By distributing the selection of the battery packs comprised in the first set of battery packs and/or the second set of battery packs equally, aging of the battery packs in the electrical vehicle is evenly distributed, which is advantageous from a technical life time perspective of the vehicle.

Optionally, the first set of battery packs and the second set of battery packs may constitute all battery packs of the vehicle.

According to a second aspect of the invention, this objective is achieved by a controller of an electric vehicle that manages multiple battery packs within the vehicle. Each battery pack is associated with a heating arrangement, which is designed to individually adjust the temperature of each respective battery pack. The controller is configured to detect a battery temperature below a lower threshold level for all battery packs using temperature sensors. When the battery temperature is detected below the lower threshold level, the controller allow the heating arrangement to provide heat to a first set of battery packs from the multiple battery packs while preventing the heating arrangement from providing heat to a second set of battery packs from the multiple battery packs. The first set of battery packs is distinct from the second set of battery packs.

Thereby, the available power of the battery packs is focused on heating a limited amount of battery packs of the vehicle instead of diluting the available battery power to heat all the battery packs simultaneously, as is made in prior art solutions. The time it takes to heat the limited amount of battery packs of the vehicle to an operative temperature wherein the battery pack has a low/ lower internal resistance and therefore high power output is reduced.

Optionally, the controller may be configured to monitor battery temperature of the battery packs comprised in the first set of battery packs via the temperature sensor. Also, the controller may be configured to disallow the heating arrangement to provide heat to the first set of battery packs and allow the heating arrangement to provide heat to the second set of battery packs when the monitored battery temperature of the battery packs in the first set of battery packs exceeds an upper threshold level.

When the temperature of the first set of battery packs has reached the upper threshold level, the output power performance of the first set of battery packs has increased due to reduced internal resistance as a consequence of the increased temperature, to a level allowing the power output according to the demands of the electric vehicle. The critical phase during the beginning of the cold-start take off with very cold battery packs is over. By shifting focus to heat up the second set of battery packs, the capacity in terms of available power output of these battery packs is increased.

Optionally, the controller may also be configured to estimate SOC of each respective battery pack. The controller may in addition be configured to adjust the lower threshold level and/or an upper threshold level of the battery temperature, based on the estimated SOC.

The output power capacity of the battery packs is deteriorating with falling temperature, but is also affected by decreasing SOC. By adjusting the lower threshold level and/or the upper threshold level of the battery temperature taking regard to the estimated SOC, a better precision in achieving a certain required power demand of the electric vehicle is provided.

Optionally, the lower threshold level and/or the upper threshold level of the battery temperature may be adjusted by the controller based on power requirements of the vehicle and/or available power in the first set of battery packs.

By adjusting the lower threshold level and/or the upper threshold level of the battery temperature taking regard to the power requirements of the vehicle and/or available power in the first set of battery packs, efficient heating of the battery packs is provided.

Optionally, the controller may be configured to select battery packs comprised in the first set of battery packs and/or the second set of battery packs based on historical data over previously made selections for distributing the selection equally over time.

By distributing the selection of the battery packs comprised in the first set of battery packs and/or the second set of battery packs equally, aging of the battery packs in the electrical vehicle is evenly distributed, which is advantageous from a technical lifetime perspective of the vehicle.

According to a third aspect of the invention, this objective is achieved by an electric vehicle comprising several battery packs, each associated with a heating arrangement designed to individually adjust the temperature of each respective battery pack. The vehicle is also equipped with a controller according to the second aspect, and a temperature sensor that is communicatively connected to the controller.

An electric vehicle is thereby provided that is enabled to operate at a required power after a minimal or at least reduced heating time, also when starting the vehicle with cold batteries. Usage of electrical heavy vehicles in arctic/subarctic climate zones in wintertime, or other environments with cold temperatures, is thereby enabled, without losing operative capacity.

Optionally, the heating arrangement may comprise a battery heater, configured to heat a fluid. The heating arrangement may also comprise a number of heat exchangers, each one configured to increase temperature of one respective battery pack. The heating arrangement may in addition comprise a pipeline, connected to the battery heater, configured to forward heated fluid from the battery heater to the heat exchangers. The heating arrangement may also comprise a plurality of fluid regulators, each communicatively connected to the controller, and configured to either allow, or disallow heated fluid from the pipeline to reach a respective heat exchanger.

A convenient solution for unevenly heating the battery packs is thereby provided.

Optionally, the heating arrangement may comprise a plurality of battery heaters, each communicatively connected to the controller, and configured to increase temperature of one respective battery pack.

An alternative solution for unevenly heating the battery packs is thereby provided.

According to a fourth aspect of the invention, this objective is achieved by a computer program comprising program code for performing a method according to the first aspect when the computer program is executed in a controller according to the second aspect.

According to a fifth aspect of the invention, this objective is achieved by a computer-readable medium comprising instructions which, when executed by the controller according to the second aspect, cause the controller to carry out the steps of the method according to the first aspect.

Hereby a heating strategy is disclosed that focuses on uneven heating of the battery packs of the vehicle in order to create temperature difference between the battery pack. The strategy is to provide heating only to one or some few battery packs by the heater instead of heating all the battery packs onboard.

By maintaining the temperature of the first set of propulsion battery packs within optimal ranges, the performance, efficiency, and longevity of the battery packs are ensured, thereby extending the vehicle's driving range and overall lifespan.

Other advantages and additional novel features will become apparent from the subsequent detailed description.

### FIGURES

Embodiments of the invention will now be described in further detail with reference to the accompanying figures, in which:

FIG. 1 illustrates a side view of a vehicle with a plurality of battery packs;

FIG. 2A illustrates an embodiment of an electric propulsion arrangement in an electric vehicle with a plurality of battery packs and a heating arrangement;

FIG. 2B illustrates an embodiment of an electric propulsion arrangement in an electric vehicle with a plurality of battery packs and a heating arrangement;

FIG. 3A-3B illustrate a comparison of normalized output power of a battery pack at different temperatures and states of charges;

FIG. 4A-4B illustrate a comparison of normalized internal resistance of a battery pack at different temperatures and states of charges;

FIG. 5 is a flow chart illustrating an embodiment of a method.

### DETAILED DESCRIPTION

Embodiments of the invention described herein are defined as a method, a controller, computer program, computer readable medium and an electric vehicle, which may be put into practice in the embodiments described below. These embodiments may, however, be exemplified and realized in many different forms and are not to be limited to the examples set forth herein; rather, these illustrative examples of embodiments are provided so that this disclosure will be thorough and complete.

Still other objects and features may become apparent from the following detailed description, considered in conjunction with the accompanying drawings. It is to be understood, however, that the drawings are designed solely for purposes of illustration and not as a definition of the limits of the herein disclosed embodiments, for which reference is to be made to the appended claims. Further, the drawings are not necessarily drawn to scale and, unless otherwise indicated, they are merely intended to conceptually illustrate the structures and procedures described herein.

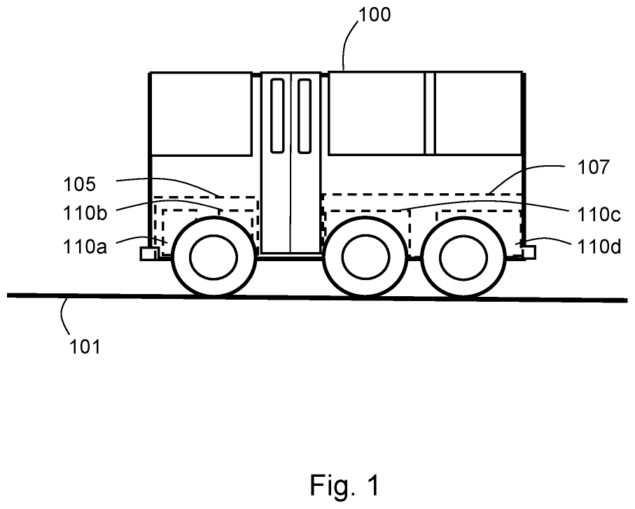

FIG. 1 illustrates a scenario with a vehicle 100 driving on a road 101. The vehicle 100 comprises a plurality of rechargeable battery packs 110a, 110b, 110c, 110d, i.e. at least two battery packs 110a, 110b, 110c, 110d. The battery packs 110a, 110b, 110c, 110d may be charged e.g. at a charging station during standstill, via an induction coil in/under the road 101 and/or via conductive electrical transmission from an overhead energy transfer segment via a roof mounted pantograph, for example. When the vehicle 100 decelerates or brakes, the energy generated by the regenerative braking system may be fed back into the battery packs 110a, 110b, 110c, 110d, recharging them, in some possible embodiments.

The term “battery pack” is in this context to be understood as a high-capacity energy storage system comprising multiple individual battery cells connected in series and parallel configurations. These cells may for example be lithium-ion based, as lithium-ion batteries offer a high energy density, long cycle life, and relatively low self-discharge. However, some other examples of battery cells may comprise lead-acid, nickel-cadmium, nickel-metal hydride. Other terminology sometimes used for the term “battery pack” in other literature may be e.g. battery, traction battery, electric vehicle battery, battery cells, battery module/s, power pack, etc.

The battery packs 110a, 110b, 110c, 110d stores and releases electrical energy to power one or several electric motor(s), which in turn propels the vehicle 100. During acceleration, the battery packs 110a, 110b, 110c, 110d discharges energy, providing power to the motor.

The vehicle 100 may be any kind of vessel for conveyance requiring and comprising a plurality of battery packs 110a, 110b, 110c, 110d for fulfilling their operational requirements on power and range. These battery packs 110a, 110b, 110c, 110d are arranged in series and/or in parallel to provide necessary voltage/power performance. Some examples of such vehicle 100 may be e.g. a truck, a bus, a van, a mining vehicle, a railway vehicle, a tram, an agricultural vehicle, an excavator, a military vehicle/tank, an unmanned aircraft system, a drone, a snow mobile, a mobile robot, a boat, a submarine, a hovercraft, an aeroplane, a helicopter, a spacecraft, an extra-terrestrial exploration rover, a satellite, a cruising missile, a rocket or similar vessel.

The vehicle 100 may be configured for running on a road, in terrain, on rail, on a construction site or in a mine, for example; alternatively in/under the water, on snow, on ice, in the air, in space, extra-terrestrial terrain, etc.

The vehicle 100 may be driver controlled or driverless autonomously controlled vehicles in different embodiments. However, for enhanced clarity, the vehicle 100 is subsequently described as a terrestrial vehicle having a driver.

The battery packs 110a, 110b, 110c, 110d of the vehicle 100 are organized in at least a first set 105 of battery packs 110a, 110b, 110c, 110d and a second set 107 of battery packs 110a, 110b, 110c, 110d, wherein the first set 105 of battery packs 110a, 110b, 110c, 110d is distinct from the second set 107 of battery packs 110a, 110b, 110c, 110d. Each one of the first set 105 of battery packs 110a, 110b, 110c, 110d and second set 107 of battery packs 110a, 110b, 110c, 110d may comprise one single battery pack 110a, 110b, 110c, 110d, or several battery packs 110a, 110b, 110c, 110d.

In cold start, especially at sub-zero temperatures, time required to raise available power to sufficient levels is critical characteristic of the product. For example, at −10° C., available power from the of battery packs 110a, 110b, 110c, 110d is several times lower than the power available at 10° C. (non-limiting examples of temperatures). Therefore, power delivered by the battery packs 110a, 110b, 110c, 110d is limited when the battery packs 110a, 110b, 110c, 110d are at sub-zero temperatures.

A solution to this issue, in order to minimize the time taken to reach sufficient power (for normal operations) at the cold start of the heavy electric vehicle 100 is to provide an uneven heating of the battery packs 110a, 110b, 110c, 110d, by limiting heating to one set 105 of battery packs 110a, 110b, 110c, 110d. The set 105 of battery packs 110a, 110b, 110c, 110d may comprise one single battery pack 110a, 110b, 110c, 110d or some few battery packs 110a, 110b, 110c, 110d.

Thereby, the available power of the battery packs 110a, 110b, 110c, 110d is focused on heating a limited amount of battery packs 110a, 110b, 110c, 110d of the vehicle 100 instead of diluting the available battery power to heat all the battery packs 110a, 110b, 110c, 110d simultaneously, as is made in prior art solutions. Thereby, the time it takes to heat the limited amount of battery packs 110a, 110b, 110c, 110d of the vehicle 100 to an operative temperature wherein the battery pack 110a, 110b, 110c, 110d has a low/lower internal resistance and therefore high power output is reduced.

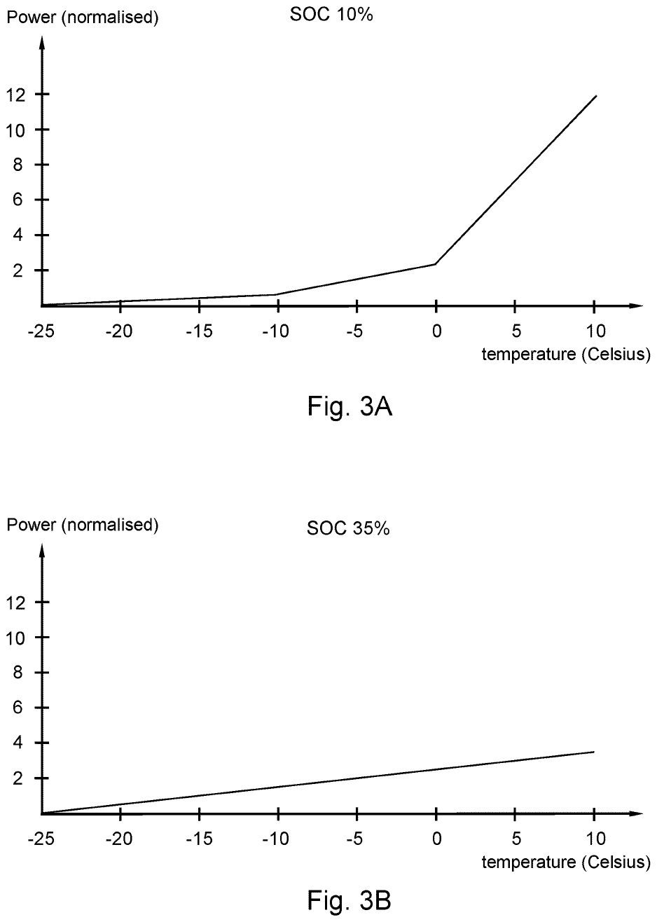

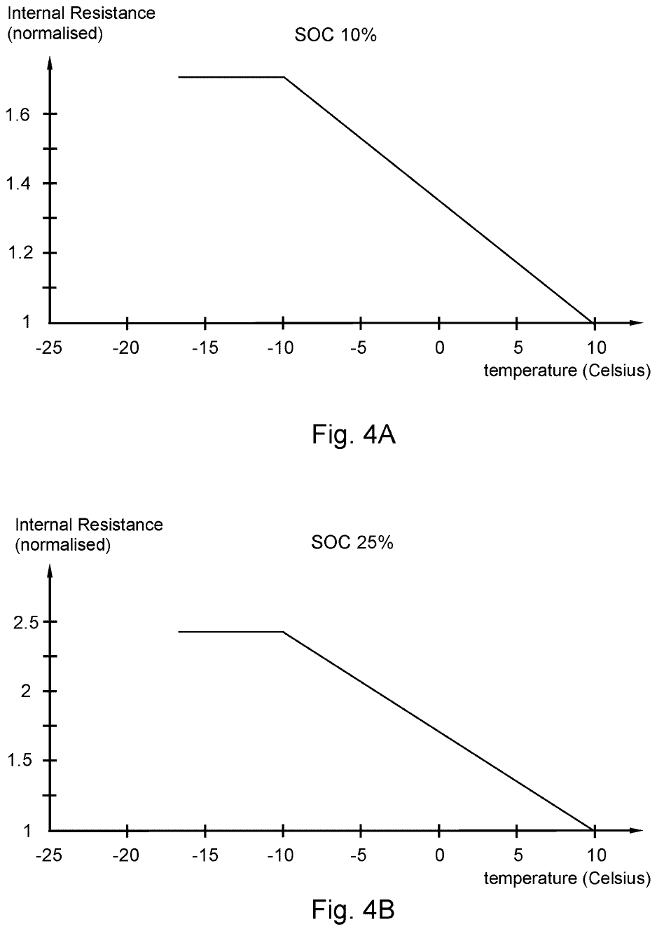

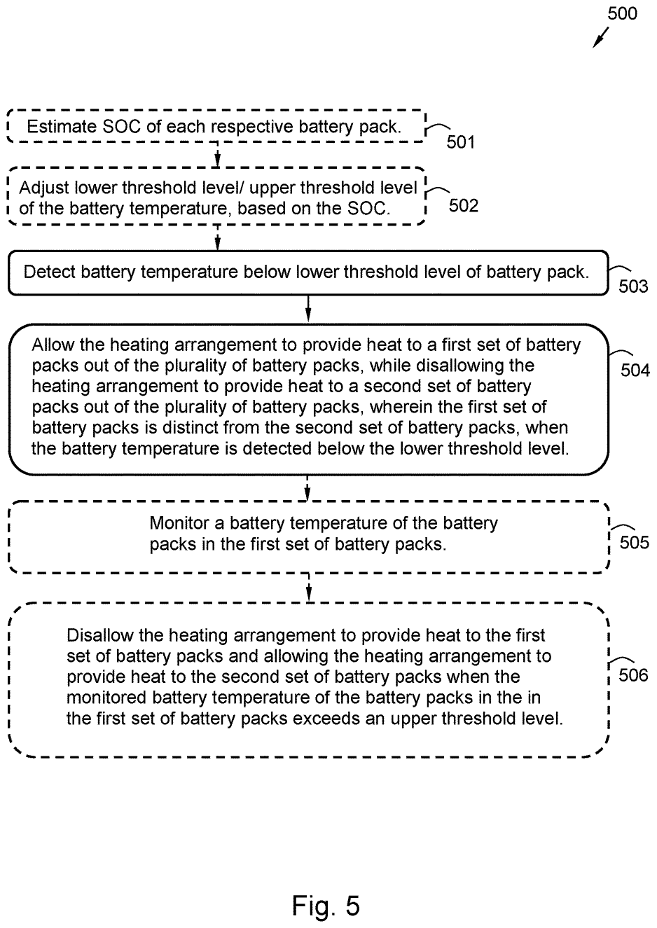

A method for implementing this solution is illustrated in FIG. 5 and discussed in the corresponding section of the description. Examples illustrating the relation between internal resistance and temperature of a battery pack 110a, 110b, 110c, 110d at some different SOC are illustrated in FIGS. 4A-4B while the relation between power and temperature of the battery pack 110a, 110b, 110c, 110d at some different SOC are illustrated in FIGS. 3A-3B.

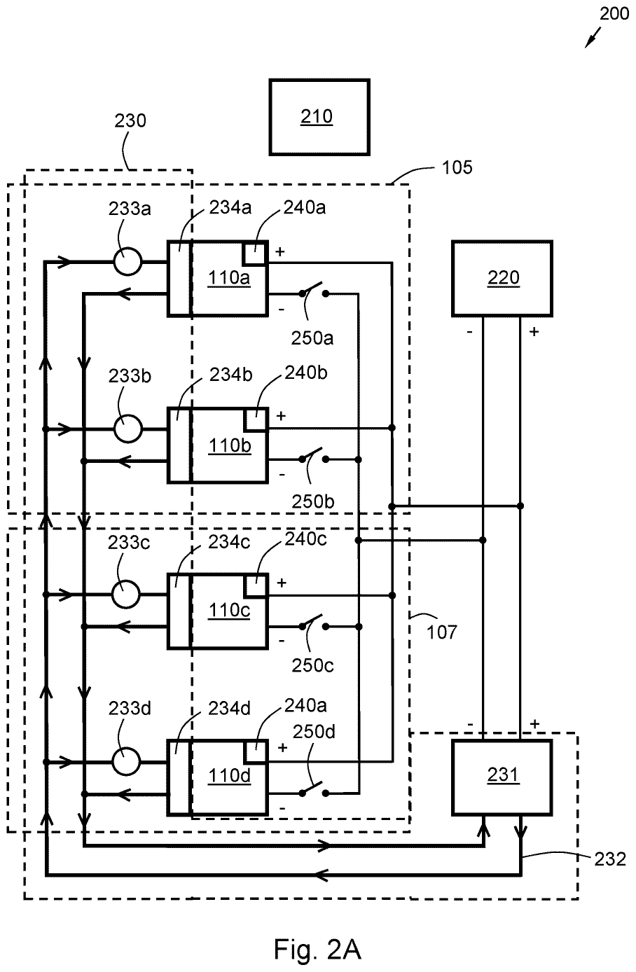

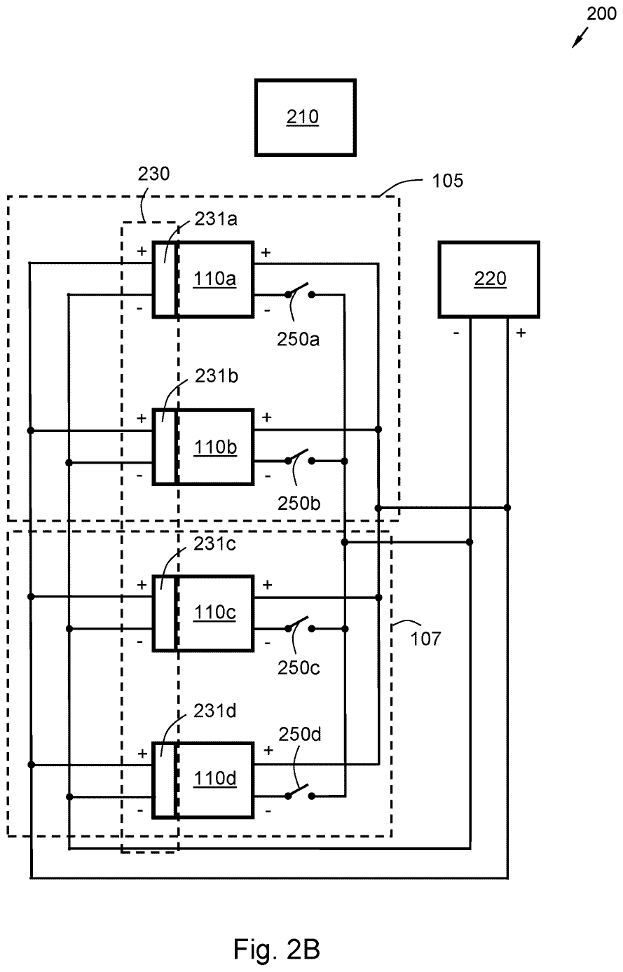

The electric vehicle 100 comprises a system 200, as illustrated in FIGS. 2A-2B, each illustrating an example of an embodiment, for battery management and surveillance. The system 200 may comprise a controller 210 which is a component configured for monitoring of e.g. SOC, State of Health (SOH), temperature, and voltage of the respective battery packs 110a, 110b, 110c, 110d, thereby ensuring safe and efficient operation. Additionally, the controller 210 may balance the charge and discharge rates of the battery packs 110a, 110b, 110c, 110d to maximize performance and prolong the battery packs' overall lifespan.

The battery packs 110a, 110b, 110c, 110d are energizing various electricity consumers 220 of the vehicle 100 such as electrical motor for propulsion, heater of the cabin, head lights, etc.

The controller 210 also performs thermal management of the battery packs 110a, 110b, 110c, 110d by controlling and adjusting temperature of the battery packs 110a, 110b, 110c, 110d via a heating arrangement 230.

The heating arrangement 230 is configured to adjust temperature of each respective battery pack 110a, 110b, 110c, 110d individually. It thereby becomes possible to focus on heating only one battery pack 110a, 110b, 110c, 110d, or a set 105 of battery packs 110a, 110b, 110c, 110d in a scenario where the temperature is very low, such as lower than a lower threshold level.

The optimal temperature range of the battery packs 110a, 110b, 110c, 110d may be estimated to about 20° C. and 40° C. for ensuring optimal power performance, safety, and longevity of the battery packs 110a, 110b, 110c, 110d.

The concept of the present solution is focusing on the particular case when the vehicle 100 has been parked outside or in an unheated garage (or the temperature of the battery packs 110a, 110b, 110c, 110d for other reason has fallen below the lower threshold level).

The journey of the professional heavy vehicle 100 is typically planned in advance; also the charging and heating administration of the battery packs 110a, 110b, 110c, 110d are typically planned, why a temperature of the battery packs 110a, 110b, 110c, 110d below the lower threshold level may be expected only in exceptional cases, for example in case of an emergency stop, or similar case. The typical way of heating the battery packs 110a, 110b, 110c, 110d during parking is naturally to charge the battery packs 110a, 110b, 110c, 110d at a charging station and/or use electricity from the charging station to run the heating arrangement 230 to heat all the battery packs 110a, 110b, 110c, 110d, maintaining them above the lower threshold level, and perhaps preferably in the optimal temperature range.

The controller 210 is configured to detect a battery temperature below a lower threshold level of all battery packs 110a, 110b, 110c, 110d via a temperature sensor 240a, 240b, 240c, 240d. In some embodiments, one respective temperature sensor 240a, 240b, 240c, 240d may be arranged at each battery pack 110a, 110b, 110c, 110d, for enabling a continuous monitoring of the battery temperature. However, optionally the controller 210 may estimate that the temperature of all battery packs 110a, 110b, 110c, 110d is below the lower threshold level for example when the vehicle 100 has been parked outside in a cold environmental temperature longer than a certain period of time, without being connected to a charging station, for example (as may be estimated based on various sensors).

The controller 210 is also configured to allow, when the battery temperature is detected below the lower threshold level, the heating arrangement 230 to provide heat to a first set 105 of battery packs 110a, 110b, 110c, 110d, out of the plurality of battery packs 110a, 110b, 110c, 110d in the vehicle 100. Meanwhile, the controller 210 disallows the heating arrangement 230 to provide heat to a second set 107 of battery packs 110a, 110b, 110c, 110d, out of the plurality of battery packs 110a, 110b, 110c, 110d of the vehicle 100. The first set 105 of battery packs 110a, 110b, 110c, 110d, is distinct from the second set 107 of battery packs 110a, 110b, 110c, and 110d.

The lower threshold level of the battery temperature may be set to a temperature e.g. in an interval between −20° C. and 10° C., such as for example about −10° C., about 0° C. or somewhere in between.

The lower threshold level of the battery temperature, as well as an upper threshold level may be adjusted by the controller 210 in some embodiments, e.g. based on an estimated SOC of the respective battery packs 110a, 110b, 110c, 110d; and/or based on power requirements of the vehicle 100 and/or available power in the first set 105 of battery packs 110a, 110b, 110c, 110d.

The controller 210 is also configured to select the battery packs 110a, 110b, 110c, 110d comprised in the first set 105 of battery packs 110a, 110b, 110c, 110d and/or the second set 105 of battery packs 110a, 110b, 110c, 110d based on historical data over previously made selections for distributing the selection equally over time.

An advantage therewith is that aging of the battery packs 110a, 110b, 110c, 110d thereby is evenly distributed among the battery packs 110a, 110b, 110c, 110d.

The controller 210 may also be configured to, during propulsion of the vehicle 100 when uneven distribution of heating has been provided to the battery packs 110a, 110b, 110c, 110d, monitor battery temperature of the battery packs 110a, 110b, 110c, 110d comprised in the first set 105 of battery packs 110a, 110b, 110c, 110d via the temperature sensor 240a, 240b, 240c, 240d.

In addition, the controller 210 may be configured to disallow the heating arrangement 230 to provide heat to the first set 105 of battery packs 110a, 110b, 110c, 110d and allowing the heating arrangement 230 to provide heat to the second set 107 of battery packs 110a, 110b, 110c, 110d when the monitored battery temperature of the battery packs 110a, 110b, 110c, 110d in the first set 105 of battery packs 110a, 110b, 110c, 110d exceeds an upper threshold level.

The upper threshold level may be set to a temperature e.g. in an interval between 0° C. and 20° C., such as for example about 5° C., about 10° C., or about 15° C. or somewhere in between. As already stated above, the upper threshold level as well as the lower threshold level may be dynamically adjusted based on e.g. estimated SOC of the respective battery packs 110a, 110b, 110c, 110d; and/or based on power requirements of the vehicle 100 and/or available power in the first set 105 of battery packs 110a, 110b, 110c, 110d.

The vehicle 100, i.e. the system 200 may also comprise a respective switch 250a, 250b, 250c, 250d for each battery pack 110a, 110b, 110c, 110d. Each of the switches 250a, 250b, 250c, 250d may be communicatively connected to the controller 210. The controller 210 is thereby enabled to disconnect output of electricity of one or several battery packs 110a, 110b, 110c, 110d in some embodiments, such as for example cold battery packs 110a, 110b, 110c, 110d, i.e. battery packs 110a, 110b, 110c, 110d that are not comprised in the heated first set 105 of battery packs 110a, 110b, 110c, 110d. Thus, in some embodiments, only the hot or heated first set 105 of battery packs 110a, 110b, 110c, 110d may be used for propulsion of the vehicle 100, and for other consumers 220 of electrical power and the heating arrangement 230.

The heating arrangement 230 as illustrated in FIG. 2A comprises a battery heater 231, configured to heat a fluid, which may comprise a liquid sometimes called a coolant (water/glycol mixture) or a gas such as air. The battery heater 231 may comprise an electric heating element providing resistive heating or possibly a heat pump. The warmed fluid may be provided via a pipeline 232 to a respective heat exchanger 234a, 234b, 234c, 234d associated with each individual battery pack 110a, 110b, 110c, 110d. The heated fluid thereby transfer heat to the respective battery pack 110a, 110b, 110c, 110d, and cooled fluid is circulated back to the battery heater 231.

Each heat exchanger 234a, 234b, 234c, 234d may be associated with a respective fluid regulator 233a, 233b, 233c, 233d, which fluid regulator 233a, 233b, 233c, 233d may be communicatively connected to the controller 210. The fluid regulator 233a, 233b, 233c, 233d may comprise e.g. either a valve or a pump.

The controller 210 is configured to allow/disallow heated fluid to circulate to the battery packs 110a, 110b, 110c, 110d by opening/closing the respective fluid regulator 233a, 233b, 233c, 233d, thereby allowing heated fluid to circulate to the battery packs 110a, 110b, 110c, 110d of the first set 105 of battery packs 110a, 110b, 110c, 110d while disallowing the heated fluid to circulate to the battery packs 110a, 110b, 110c, 110d of the second set 107 of battery packs 110a, 110b, 110c, 110d.

The heat exchanger 234a, 234b, 234c, 234d of the battery pack/s 110a, 110b, 110c, 110d that is/are desired to be heated is thereby provided with heated fluid from the battery heater 231 via the pipeline 232. The heated fluid is then allowed to circulate through the battery pack/s 110a, 110b, 110c, 110d that is/are desired to be heated to increase its temperature.

Hereby an efficient heating of the battery packs 110a, 110b, 110c, 110d is provided, offering a precise temperature control of the battery packs 110a, 110b, 110c, 110d.

The heating arrangement 230 as illustrated in FIG. 2B comprises a plurality of battery heaters 231a, 231b, 231c, 231d, each communicatively connected to the controller 210, and configured to increase temperature of one respective battery pack 110a, 110b, 110c, 110d.

Each one of the battery heaters 231a, 231b, 231c, 231d may comprise electric heating elements, such as resistive wires or flexible heating pads, placed in contact with the corresponding respective battery pack 110a, 110b, 110c, 110d, or embedded within the respective battery pack 110a, 110b, 110c, 110d. When an electric current is passed through the heating elements, they generate heat, which is then transferred to the battery pack 110a, 110b, 110c, 110d.

Each one of the battery heaters 231a, 231b, 231c, 231d may be communicatively connected to the controller 210, and configured to increase temperature of one respective battery pack 110a, 110b, 110c, 110d.

The controller 210 may thereby be configured to allow heating the battery packs 110a, 110b, 110c, 110d of the first set 105 of battery packs 110a, 110b, 110c, 110d while disallowing the heated fluid to circulate to the battery packs 110a, 110b, 110c, 110d of the second set 107 of battery packs 110a, 110b, 110c, 110d, by activating/deactivating the corresponding battery heater 231a, 231b, 231c, 231d.

Resistive heating of the battery packs 110a, 110b, 110c, 110d by the respective battery heater 231a, 231b, 231c, 231d is easily implemented and reliable.

FIG. 3A and FIG. 3B schematically illustrate some examples of variation of available power (normalized) and internal resistance for a particular cell chemistry across different battery temperatures at different SOC levels.

Available power from the battery depends heavily on the temperature and state of charge (SOC level) of the battery packs 110a, 110b, 110c, 110d. Therefore, the electric vehicle 100 is equipped with the BMS 200, and the controller 210 that via the temperature sensors 240a, 240b, 240c, 240d may monitor the temperature of the battery packs 110a, 110b, 110c, 110d and heating of the first set 105 of battery packs 110a, 110b, 110c, 110d for optimal power performance.

The available power of the battery packs 110a, 110b, 110c, 110d is very low at cold temperatures for a 10% SOC as illustrated in FIG. 3A. At temperatures lower than −10° C., or there about, the available power (normalized in the figure) is very low in comparison, and the increase of the available power with increased temperature is low. Between −10° C. and up to about 0° C., the available power increases a bit more rapid, yet quite moderate. In warmer battery temperature than 0° C., the available power increases rapidly with increased temperature.

FIG. 3B illustrates available power of the battery packs 110a, 110b, 110c, 110d at 35% SOC. The available power increases substantially linearly with increased temperature.

The lower threshold level of the battery temperature may be set to a temperature e.g. in an interval between −20° C. and 10° C., such as for example about −10° C., about 0° C., or somewhere in between. The upper threshold level of the battery temperature may correspondingly be set to a temperature e.g. in an interval between 0° C. and 20° C., such as for example about 5° C., about 10° C., or about 15° C. or somewhere in between.

The lower threshold level and/or the upper threshold level of the battery temperature for triggering the discussed method may be dynamically set based on e.g. estimated SOC of the respective battery packs 110a, 110b, 110c, 110d; and/or based on power requirements of the vehicle 100 and/or available power in the first set 105 of battery packs 110a, 110b, 110c, 110d.

FIGS. 4A-4B illustrate internal resistance of battery packs 110a, 110b, 110c, 110d in the vehicle 100 and its dependency on temperature at different SOC.

Internal resistance in this context refers to the opposition to the flow of electric current within the battery packs 110a, 110b, 110c, 110d. It is the combined effect of various factors, comprising the resistance of the battery's electrodes, electrolyte, and current collectors. Internal resistance plays a crucial role in determining performance, efficiency, and lifespan of the battery packs 110a, 110b, 110c, 110d.

The internal resistance may change depending on the temperature and the SOC of the respective battery pack 110a, 110b, 110c, 110d.

Generally, as the temperature of the battery pack 110a, 110b, 110c, 110d increases, its internal resistance decreases. Higher temperatures improve the conductivity of the electrolyte and the electrode reactions, leading to reduced internal resistance. Low temperatures slow down the electrode reactions and decrease the electrolyte's conductivity, which increases the internal resistance and reduces the performance of the battery pack 110a, 110b, 110c, 110d and available power output.

The internal resistance of the battery pack 110a, 110b, 110c, 110d also changes depending on its SOC, as may be seen when studying FIG. 4A in conjunction with FIG. 4B. Typically, the internal resistance is higher when the battery pack 110a, 110b, 110c, 110d is at a low SOC and lower when it is at a high SOC. This is because, at lower SOC, the available surface area for electrochemical reactions is reduced, and the electrolyte concentration is less favourable, leading to increased internal resistance.

Thanks to the provided solution, by monitoring temperature of the battery pack 110a, 110b, 110c, 110d and in some embodiments also the SOC, internal resistance may be decreased for maintaining optimal performance and prolong battery life by regulating battery temperature of a selected first set 105 of battery packs 110a, 110b, 110c, 110d.

FIG. 5 illustrates an example of a method 500 according to an embodiment. The flow chart in FIG. 5 shows the method 500 performed by a controller 210 of an electric vehicle 100. The electric vehicle 100 comprises a plurality of battery packs 110a, 110b, 110c, 110d, each associated with a heating arrangement 230, which heating arrangement 230 is configured to adjust temperature of each respective battery pack 110a, 110b, 110c, 110d individually.

The electric vehicle 100 may be a heavy vehicle for professional transportation, such as for example an articulated truck-trailer combination, a bus, a truck, a lorry, etc, or any of the previously exemplified vessels.

In order to correctly be able to adjust temperature of each of the battery packs 110a, 110b, 110c, 110d of the vehicle 100 individually/separately, the method 500 may comprise a number of steps 501-506. However, some of these steps 501-506 may be performed solely in some alternative embodiments, like e.g. steps 501-502 or steps 505-506. Further, the described steps 501-506 may be performed in a somewhat different chronological order than the numbering suggests. The method 500 may comprise the subsequent steps:

Step 501, which may be performed in some alternative embodiments, comprises estimating SOC of each respective battery pack 110a, 110b, 110c, 110d.

The SOC of the battery packs 110a, 110b, 110c, 110d may be estimated by the controller 210 based on one or a combination of methods, such as voltage-based estimation, coulomb counting, impedance spectroscopy, model-based estimation and/or machine learning and data-driven methods.

Voltage-based estimation: Battery voltage is often correlated with SOC, as it tends to change with charge levels. By measuring the Open-Circuit Voltage (OCV) of the battery pack 110a, 110b, 110c, 110d and comparing it with the voltage-SOC curve, the SOC may be estimated.

Coulomb counting: This method, also known as ampere-hour (Ah) counting, involves measuring the current flowing into or out of the battery pack 110a, 110b, 110c, 110d over time. By integrating the current over time, the total charge delivered or consumed can be calculated, providing an estimate of the SOC.

Impedance spectroscopy: This method involves applying an AC voltage or current signal to the battery pack 110a, 110b, 110c, 110d and measuring the resulting impedance response across a range of frequencies. The SOC can be estimated by analysing the battery pack's Electrochemical Impedance Spectroscopy (EIS) data, which reveals information about the internal processes and properties battery pack 110a, 110b, 110c, 110d.

Model-based estimation: This approach employs mathematical models, such as equivalent circuit models or electrochemical models, to describe the behavior of the battery pack 110a, 110b, 110c, 110d. By using measured voltage, current, and temperature data, along with the model parameters, the SOC can be estimated using state estimation techniques like Kalman filtering or Extended Kalman Filtering (EKF).

Machine learning and data-driven methods: Advanced techniques, such as Artificial Neural Networks (ANNs) and Support Vector Machines (SVMs), can be trained on historical battery data to estimate SOC.

A combination of at least some of these methods, such as using voltage-based estimation and coulomb counting together, or employing model-based estimation with data-driven techniques, can provide more accurate and reliable SOC estimates.

Step 502, which may be performed in some embodiments wherein step 501 has been performed, comprises adjusting the lower threshold level and/or an upper threshold level of the battery temperature of the battery packs 110a, 110b, 110c, 110d, based on the estimated 501 SOC.

The lower threshold level and/or the upper threshold level of the battery temperature may be adjusted 502 based on power requirements of the vehicle 100 and/or available power in the first set 105 of battery packs 110a, 110b, 110c, 110d.

Thus, high power requirements of the vehicle 100 may require an increase of the upper threshold level of the battery temperature.

Step 503 comprises detecting a battery temperature below a lower threshold level of all the battery packs 110a, 110b, 110c, 110d.

The battery temperature may be determined based on one or several temperature sensors 240a, 240b, 240c, 240d, communicatively connected to the controller 210.

Step 504 comprises allowing the heating arrangement 230 to provide heat to a first set 105 of battery packs 110a, 110b, 110c, 110d out of the plurality of battery packs 110a, 110b, 110c, 110d, while disallowing the heating arrangement 230 to provide heat to a second set 107 of battery packs 110a, 110b, 110c, 110d out of the plurality of battery packs 110a, 110b, 110c, 110d, wherein the first set 105 of battery packs 110a, 110b, 110c, 110d is distinct from the second set 107 of battery packs 110a, 110b, 110c, 110d, when the battery temperature is detected 503 below the lower threshold level.

The battery packs 110a, 110b, 110c, 110d comprised in the first set 105 of battery packs 110a, 110b, 110c, 110d and/or the second set 105 of battery packs 110a, 110b, 110c, 110d may be selected based on historical data over previously made selections for distributing the selection equally over time.

An advantage therewith is to equalise life length of the onboard battery packs 110a, 110b, 110c, 110d.

The first set 105 of battery packs 110a, 110b, 110c, 110d may comprise one single battery pack 110a, 110b, 110c, 110d, or some few battery packs 110a, 110b, 110c, 110d such as two, three, four, etc.

The first set 105 of battery packs 110a, 110b, 110c, 110d and the second set 105 of battery packs 110a, 110b, 110c, 110d may together constitute all battery packs 110a, 110b, 110c, 110d of the vehicle 100, in some embodiments.

Step 505, which may be performed in some alternative embodiments, comprises monitoring a battery temperature of the battery packs 110a, 110b, 110c, 110d comprised in the first set 105 of battery packs 110a, 110b, 110c, 110d.

The monitoring of temperature may be made based on repeated temperature measurements made by the temperature sensors 240a, 240b, 240c, 240d, which measurements may repeatedly be transmitted to the communicatively connected controller 210.

Step 506, which may be performed in some embodiments wherein step 501 has been performed, comprises disallowing the heating arrangement 230 to provide heat to the first set 105 of battery packs 110a, 110b, 110c, 110d and allowing the heating arrangement 230 to provide heat to the second set 107 of battery packs 110a, 110b, 110c, 110d when the monitored 505 battery temperature of the battery packs 110a, 110b, 110c, 110d in the in the first set 105 of battery packs 110a, 110b, 110c, 110d exceeds the upper threshold level.

The controller 210 may comprise or be referred to as a computer, comprising any hardware or hardware/firmware device implemented using processing circuity such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, an application-specific integrated circuit, or any other device capable of electronically performing operations in a defined manner.

The controller 210 may further comprise a receiving circuit configured for receiving a signal from various communicatively connected entities on the vehicle 100, such as the temperature sensors 240a, 240b, 240c, 240d, the battery heater/s 231, 231a, 231b, 231c, 231d, the fluid regulators 233a, 233b, 233c, 233d, the respective switch 250a, 250b, 250c, 250d for each battery pack 110a, 110b, 110c, 110d, for example in different embodiments.

Furthermore, the controller 210 may comprise a memory in some embodiments. The optional memory may comprise a physical device utilized to store data and/or programs, i.e., sequences of instructions, on a temporary or permanent basis. According to some embodiments, the memory may comprise integrated circuits comprising silicon-based transistors. The memory may comprise e.g. a memory card, a flash memory, a USB memory, a hard disc, or another similar volatile or non-volatile storage unit for storing data such as e.g. ROM (Read-Only Memory), PROM (Programmable Read-Only Memory), EPROM (Erasable PROM), EEPROM (Electrically Erasable PROM), etc. in different embodiments.

Further, the controller 210 may comprise a signal transmitter. The signal transmitter may be configured for transmitting a control signal to be received by the communicatively connected entities.

The previously described method steps 501-506 of the method 500 to be performed by the controller 210 may be implemented through the one or more processors within the by the controller 210, together with computer program product for performing at least some of the functions of the method steps 501-506. Thus, a computer program product, comprising instructions for performing the method steps 501-506 in the controller 210 may perform the method 500 comprising at least some of the method steps 501-506 for adjusting temperature of the battery packs 110a, 110b, 110c, 110d in the electrical vehicle 100 via a heating arrangement 230, when the computer program is loaded into the one or more processors of the controller 210.

The computer program product mentioned above may be provided for instance in the form of a computer-readable medium. In some embodiments, the computer-readable medium may be a non-transitory computer-readable medium, such as a tangible electronic, magnetic, optical, infrared, electromagnetic, and/or semiconductor system, apparatus, and/or device.

The computer-readable medium may carry a computer program comprising program code for performing at least some of the method steps 501-506 according to some embodiments when being loaded into the controller 210.

The computer-readable medium may in some embodiments comprise program code for performing the above-described method steps 503-504.

The computer-readable medium may in some embodiments comprise program code for performing the above-described method steps 503-506.

The computer-readable medium may in some embodiments comprise program code for performing the above-described method steps 501-504.

The computer-readable medium may in some embodiments comprise program code for performing the above-described method steps 501-506.

The terminology used in the description of the embodiments as illustrated in the accompanying drawings is not intended to be limiting of the described method 500; the controller 210; the computer program and/or the electrical vehicle 100. Various changes, substitutions and/or alterations may be made, without departing from invention embodiments as defined by the appended claims.

As used herein, the term “and/or” comprises any and all combinations of one or more of the associated listed items. The term “or” as used herein, is to be interpreted as a mathematical OR, i.e., as an inclusive disjunction; not as a mathematical exclusive OR (XOR), unless expressly stated otherwise. In addition, the singular forms “a”, “an” and “the” are to be interpreted as “at least one”, thus also possibly comprising a plurality of entities of the same kind, unless expressly stated otherwise. It will be further understood that the terms “includes”, “comprises”, “including” and/or “comprising”, specifies the presence of stated features, actions, integers, steps, operations, elements, and/or components, but do not preclude the presence or addition of one or more other features, actions, integers, steps, operations, elements, components, and/or groups thereof. A single unit such as e.g. a processor may fulfil the functions of several items recited in the claims. The mere fact that certain measures are recited in mutually different dependent claims does not indicate that a combination of these measures cannot be used to advantage. A computer program may be stored/distributed on a suitable medium, such as an optical storage medium or a solid-state medium supplied together with or as part of other hardware, but may also be distributed in other forms such as via Internet or other wired or wireless communication system.

1. A method performed by a controller of an electric vehicle, wherein the vehicle comprises a plurality of battery packs each associated with a heating arrangement which heating arrangement is configured to adjust temperature of each respective battery pack individually, wherein the method comprises:
detecting a battery temperature below a lower threshold level of all the battery packs; and
allowing the heating arrangement to provide heat to a first set of battery packs out of the plurality of battery packs, while disallowing the heating arrangement to provide heat to a second set of battery packs out of the plurality of battery packs, wherein the first set of battery packs is distinct from the second set of battery packs, when the battery temperature is detected below the lower threshold level.

2. The method according to claim 1, further comprising:
monitoring a battery temperature of the battery packs comprised in the first set of battery packs; and
disallowing the heating arrangement to provide heat to the first set of battery packs and allowing the heating arrangement to provide heat to the second set of battery packs when the monitored battery temperature of the battery packs in the first set of battery packs exceeds an upper threshold level.

3. The method according to claim 1, comprising the steps of:
estimating State of Charge of each respective battery pack; and
adjusting the lower threshold level and/or an upper threshold level of the battery temperature, based on the estimated State of Charge.

4. The method according to claim 3, wherein the lower threshold level and/or the upper threshold level of the battery temperature is adjusted based on power requirements of the vehicle and/or available power in the first set of battery packs.

5. The method according to claim 1, wherein battery packs comprised in the first set of battery packs and/or the second set of battery packs are selected based on historical data over previously made selections for distributing the selection equally over time.

6. The method according to claim 1, wherein the first set of battery packs and the second set of battery packs constitute all battery packs of the vehicle.

7. A controller of an electric vehicle, wherein the vehicle comprises a plurality of battery packs, each associated with a heating arrangement, which heating arrangement is configured to adjust temperature of each respective battery pack individually, wherein the controller is configured to:
detect a battery temperature below a lower threshold level of all battery packs via a temperature sensor; and
allow the heating arrangement to provide heat to a first set of battery packs out of the plurality of battery packs, while disallowing the heating arrangement to provide heat to a second set of battery packs out of the plurality of battery packs, wherein the first set of battery packs is distinct from the second set of battery packs, when the battery temperature is detected below the lower threshold level.

8. The controller according to claim 7, further configured to:
monitor battery temperature of the battery packs comprised in the first set of battery packs via the temperature sensor; and
disallow the heating arrangement to provide heat to the first set of battery packs and allowing the heating arrangement to provide heat to the second set of battery packs when the monitored battery temperature of the battery packs in the first set of battery packs exceeds an upper threshold level.

9. The controller according to claim 7, further configured to:
estimate State of Charge of each respective battery pack; and
adjust the lower threshold level and/or an upper threshold level of the battery temperature, based on the estimated State of Charge.

10. The controller according to claim 9, wherein the lower threshold level and/or the upper threshold level of the battery temperature is adjusted based on power requirements of the vehicle and/or available power in the first set of battery packs.

11. The controller according to claim 7, configured to select battery packs comprised in the first set of battery packs and/or the second set of battery packs based on historical data over previously made selections for distributing the selection equally over time.

12. An electric vehicle comprising:
a plurality of battery packs, each associated with a heating arrangement, which heating arrangement is configured to adjust temperature of each respective battery pack individually;
a configured to:
detect a battery temperature below a lower threshold level of all battery packs via a temperature sensor; and
allow the heating arrangement to provide heat to a first set of battery packs out of the plurality of battery packs, while disallowing the heating arrangement to provide heat to a second set of battery packs out of the plurality of battery packs, wherein the first set of battery packs is distinct from the second set of battery packs, when the battery temperature is detected below the lower threshold level; and
a temperature sensor, communicatively connected to the controller.

13. The electric vehicle according to claim 12, wherein the heating arrangement comprises:
a battery heater, configured to heat a fluid;
a number of heat exchangers, each one configured to increase temperature of one respective battery pack;
a pipeline, connected to the battery heater, configured to forward heated fluid from the battery heater to the heat exchangers; and
a plurality of fluid regulators, each communicatively connected to the controller, and configured to either allow, or disallow heated fluid from the pipeline to reach a respective heat exchanger.

14. The electric vehicle according to claim 12, wherein the heating arrangement comprises:
a plurality of battery heaters, each communicatively connected to the controller, and configured to increase temperature of one respective battery pack.

15. A computer program product stored on a non-transitory computer-readable medium, said computer program product associated with an electric vehicle, wherein the vehicle comprises a plurality of battery packs, each associated with a heating arrangement which heating arrangement is configured to adjust temperature of each respective battery pack individually, wherein said computer program product comprising computer instructions to cause a controller to perform the following operations:
detect a battery temperature below a lower threshold level of all battery packs via a temperature sensor; and
allow the heating arrangement to provide heat to a first set of battery packs out of the plurality of battery packs, while disallowing the heating arrangement to provide heat to a second set of battery packs out of the plurality of battery packs, wherein the first set of battery packs is distinct from the second set of battery packs, when the battery temperature is detected below the lower threshold level.

16. (canceled)
